(19) United States
(12) Patent Application Publication
(10) Pub. No.: US 2005/0053782 A1
(43) Pub. Date: Mar. 10, 2005

(54) Process for forming polymeric micro and nanofibers

(76) Inventors: Ayusman Sen, State College, PA (US); John V. Bedding, State College, PA (US); Bin Gu, State College, PA (US)

Correspondence Address: Douglas L. Wathen;Gifford, Krass, Groh, Sprinkle,, Anderson & Citkowski, P.C., 280 N. Old Woodward Ave., Suite 400, Birmingham, MI, 48009-5394, US

(21) Appl. No.: 10/932,905

(22) Filed: Sep. 2, 2004

Related U.S. Application Data
(60) Provisional application No. 60/500,152, filed on Sep. 4, 2003.

(51) Int. Cl. D01D 5/08; D01D 5/26; B28B 5/00

(52) U.S. Cl. 428/364; 264/517; 264/85; 425/66; 425/72.2

(57) ABSTRACT

Polymers that have extremely high melt viscosities are very difficult to extrude and stretch making it difficult to synthesize fibers of such polymers via conventional methods. A process is provided for producing a polymer fiber which involves blowing a mixture of a polymer and a gas through a nozzle such that polymer micro- and/or nano-fibers are produced. The polymer fibers are characterized in that they have a diameter less than the diameter of the outlet aperture of the nozzle.

### REFERENCE TO RELATED APPLICATION

This application claims priority of U.S. Provisional Patent Application 60/500,152, filed Sep. 4, 2003, the entire content of which is incorporated herein by reference.

### GOVERNMENT SPONSORSHIP

This work was supported by the National Science Foundation under Grant No. NIRT DMI-0210229. Accordingly, the US government may have certain rights to this invention.

### FIELD OF THE INVENTION

The present invention relates to polymeric fibers, and more particularly, to processes, compositions and apparatus for fabricating such fibers using an improved technique involving gas jets. The invention further relates to articles of manufacture including such fibers.

### BACKGROUND OF THE INVENTION

Polymers that have extremely high melt viscosities are very difficult to extrude and stretch and thus are considered “non-melt processible” (see for example Fluoroplastics, Volume 1: Non-Melt Processible Fluoroplastics, Ebnesajjad, Plastics Design Library, Norwich, NY 2000). This makes it difficult to synthesize fibers of such polymers via conventional methods such as electrospinning and melt blowing or similar processes. Special methods are required for forming fibers of PTFE and similar ultra high viscosity polymers. These methods often involve mechanical stretching of heated polymer, extrusion of pastes that are formed with fluorinated or other types of solvents, or matrices (such as in matrix spinning) or extremely aggressive chemical environments, which can be inconvenient, expensive, and/or environmentally unfriendly. There is, therefore, a need for an improved process for synthesizing polymeric microfibers and nanofibers, especially fibers of polymers that are ordinarily difficult to melt or solution process, in large quantities and at low cost. Because of the special properties of nanofibers, there is also a need for a process that can provide improved yields of nanofibers of conventionally melt-processible polymers at lower costs than existing melt-blowing and electrospinning techniques.

### SUMMARY OF THE INVENTION

A process for producing a polymer fiber is detailed herein which in one embodiment includes the step of providing an apparatus for microfiber and nanofiber production. The apparatus includes a nozzle for fiber formation. The nozzle includes a body having a bore defined therethrough and the bore has an inlet aperture and an outlet aperture. Further detailed is the first segment of the bore, proximal to the inlet aperture and having a first diameter, as well as a second segment of the bore, proximal to the outlet aperture and having a second diameter. In a preferred embodiment, the ratio of the first diameter to the second diameter ranges between 2:1-1000:1, inclusive.

A further step included in an embodiment of an inventive process is the step of providing a gas source for providing a high-pressure gas. The gas source may be coupled to the inlet aperture of the bore by a coupler, such as a connecting tube.

Another step in an embodiment of an inventive process is that of placing a polymer mass in the apparatus, such as in the bore or coupler of the apparatus.

Also included in an embodiment of an inventive process is a step of activating the gas source such that a polymer/gas mixture is formed in the apparatus, such as in the bore or coupler, the polymer is moved through the bore of the apparatus such that an extentional force acts on the polymer mass and a polymer fiber is produced.

Optionally the polymer includes a non-melt processible polymer and further optionally the polymer includes PTFE. Among other polymers optionally included are polyacrylonitrile, polyolefins, cellulose acetates, cellulose nitrites, fluoropolymers, polyamides, polyimides, polystyrene, polysulfone, polyarylamides, polybutadienes, polybutenes, polycarbonates, polyesters, polyethylene, polypropylenes, polyvinyl acetates, polyurethanes, acrylates, methacrylates, polyvinylidene chlorides, silicones, styrenes, ethylene-methacrylic acid copolymers, ethylene-vinyl acetate copolymers, polyvinylacetate-methacrylic copolymers, polyaramides, polymethylmethacrylates, and a combination thereof.

Further optionally the polymer further comprises a component selected from the group consisting of: a second polymer, an organic component, an inorganic component, a precursor component, a solvent, and a combination thereof.

A polymer fiber produced according to an embodiment of a described process has a diameter less than the diameter of the outlet aperture and in preferred option the diameter ranges from about 10 nanometers to 50 microns.

A gas included in a polymer/gas mixture is preferably an inert gas. Optionally, the gas includes a gas selected from among: nitrogen, argon, neon, air, SF₆, helium, CF₄, H₂, steam, supercritical H₂O, carbon dioxide, a C₁ —C₃ fluorinated hydrocarbon gas, a C₁-C₃ hydrocarbon gas and a combination thereof.

A further optional step includes heating the polymer. In one embodiment, the polymer is heated to a temperature below its melting point.

Also detailed herein is an inventive polymer fiber produced by a process that includes the step of providing an apparatus wherein the apparatus has a nozzle. A preferred nozzle includes a body having a bore defined therethrough, where the bore has an inlet aperture and an outlet aperture. The bore further includes a first segment proximal to the inlet aperture having a first diameter, and a second segment proximal to the outlet aperture having a second diameter. The ratio of the first diameter to the second diameter ranges between 2:1-1000:1, inclusive. Another step includes providing a gas source for providing a high pressure gas, the gas source coupled to the inlet aperture of the bore by a coupler and placing a polymer in the apparatus, such as in the bore or coupler. Also described is the step of activating the gas source such that a polymer/gas mixture is formed in the apparatus and a polymer fiber is produced. Optionally, the polymer includes PTFE.

An apparatus for producing a polymer fiber is provided which includes a nozzle, the nozzle having a body with a bore defined therethrough, as well as having an inlet aperture and an outlet aperture. The bore includes a first segment proximal to the inlet aperture having a first diameter, and a second segment proximal to the outlet aperture having a second diameter, wherein the ratio of the first diameter to the second diameter ranges between 2:1-1000:1, inclusive. Also included is a gas source for providing a high pressure gas, the gas source coupled to the inlet aperture of the bore by a coupler. Optionally, the bore tapers in diameter in a transition region between the first segment and the second segment.

In a further option, mixture of a polymer and a gas is disposed in the apparatus. Preferably, the mixture of a polymer and a gas comprises an inert gas which optionally includes a gas selected from the group consisting of: nitrogen, argon, neon, air, SF₆, helium, CF₄, H₂, steam, supercritical H₂O, carbon dioxide, a C₁-C₃ fluorinated hydrocarbon gas, a C₁-C₃ hydrocarbon gas and a combination thereof.

In one option, the polymer includes PTFE and a gas selected from the group consisting of: nitrogen, argon, neon, air, SF₆, helium, CF₄, H₂, steam, supercritical H₂O, carbon dioxide, a C₁-C₃ fluorinated hydrocarbon gas, a C₁-C₃ hydrocarbon gas and a combination thereof.

A provided apparatus optionally has a second diameter having a distance across a widest dimension ranging from 100 nanometers to 10 millimeters, inclusive, 250 nanometers to 1 millimeter, inclusive or 500 nanometers to 300 microns, inclusive.

An included gas source delivers gas at a pressure ranging from 50 psi-150,000 psi, inclusive.

Optionally, an inventive apparatus further includes a heating element in thermal communication with a polymer-containing portion of the apparatus. In another option, the apparatus includes a temperature controller operatively connected to the heating element.

A composition for use in producing a polymer fiber is provided, the composition including a polymer other than a fluoropolymer and a gas, the gas inert with respect to the polymer. Optionally, the gas includes a gas selected from the group consisting of: nitrogen, carbon dioxide, argon, neon, air, SF₆, helium, CF₄, H₂, steam, supercritical H₂O, a C₁-C₃ fluorinated hydrocarbon gas, a C₁-C₃ hydrocarbon gas, and a combination thereof. Typically, the gas is present in a concentration ranging from 0.1-40%, by weight, inclusive.

A polymer includes in an inventive composition is optionally a non-melt processible polymer. In a further option the includes a polymer selected from the group consisting of: polyacrylonitrile, polyolefins, cellulose acetates, cellulose nitrites, fluoropolymers, polyamides, polyimides, polystyrene, polysulfone, polyarylamides, polybutadienes, polybutenes, polycarbonates, polyesters, polyethylene, polypropylenes, polyvinyl acetates, polyurethanes, acrylates, methacrylates, polyvinylidene chlorides, silicones, styrenes, ethylene-methacrylic acid copolymers, ethylene-vinyl acetate copolymers, polyvinylacetate-methacrylic copolymers, polyaramides, polymethylmethacrylates and a combination thereof. In addition, the polymer may include a composite selected from the group consisting of: a polymer/polymer composite, a polymer/ceramic composite, a polymer/metal composite, a polymer/organic composite, and a combination thereof.

Another composition described herein for use in producing a polymer fiber includes a fluoropolymer and a gas, the gas inert with respect to the polymer, wherein the gas is a gas other than nitrogen at a concentration ranging from 0.01-3.5% and other than carbon dioxide. Optionally, the fluoropolymer includes PTFE and further optionally includes a composite selected from the group consisting of: a polymer/polymer composite, a polymer/ceramic composite, a polymer/metal composite and a combination thereof.

A process for producing a polymer fiber is provided that includes the steps of providing a polymer and introducing pressurized flow of a gas so as to create a flowing mixture of gas and polymer. The mixture of gas and polymer is moved through a passage, or bore, the passage having an inlet aperture and an outlet aperture. The passage has a first segment proximal to the inlet aperture having a first diameter, and a second segment proximal to the outlet aperture having a second diameter, the first diameter greater than the second diameter. A polymer fiber formed according to an inventive process has a diameter smaller than the second diameter.

A process is provided for producing a PTFE fiber in one embodiment wherein the process includes the steps of providing a PTFE polymer and heating the PTFE polymer to a temperature below 400° C. A further step includes introducing a high pressure flow of a gas so as to create a flowing mixture of gas and PTFE polymer and moving the mixture of gas and PTFE polymer through a passage or bore. The passage or bore has an inlet aperture and an outlet aperture, and also has a first segment proximal to the inlet aperture having a first diameter, and a second segment proximal to the outlet aperture having a second diameter. The first diameter is greater than the second diameter. A PTFE fiber is formed, the fiber having a diameter smaller than the second diameter. Optionally, a PTFE fiber according to an inventive process has a melting temperature above 335° C. Further optionally, the mixture of gas and PTFE polymer further includes a component selected from the group consisting of: a second polymer, an organic component, an inorganic component, a precursor component, and a combination thereof. A preferred PTFE fiber has a diameter in the range between 10 nanometers to 50 microns, inclusive.

A PTFE fiber provided according to one embodiment of the invention is characterized in that the fiber has a melting temperature above 335° C. Optionally, the PTFE fiber has a diameter in the range between 10 nanometers to 50 microns, inclusive.

Also detailed herein is an inventive article of manufacture including a PTFE fiber characterized in that the fiber has a melting temperature above 335° C. Optionally, the article is selected from the group consisting of a medical device, a fabric, a hydrophobic surface, and a semi-permeable membrane.

A PTFE fiber is provided according to one embodiment of the invention which is characterized in that the fiber has a diameter in the range of 10 nanometers to 1 micron, inclusive. Also provided in an embodiment of the invention is an article of manufacture comprising a PTFE fiber characterized in that the fiber has a diameter in the range of 10 nanometers to 1 micron, inclusive.

Described is an embodiment of an inventive process for producing a polymer fiber which includes the steps of providing a mixture of a polymer and a gas and blowing the mixture of polymer and gas through a nozzle wherein the nozzle has an outlet aperture. A polymer fiber is produced according to the invention which is characterized in that the fiber has a diameter less than the diameter of the outlet aperture of the nozzle. Optionally, the polymer includes a non-melt processible polymer and further optionally the polymer includes PTFE. Also optionally, the mixture of gas and polymer further includes a component selected from among a second polymer, an organic component, an inorganic component, a precursor component, and a combination thereof. In a particular option, the organic component is a bioactive agent.

### BRIEF DESCRIPTION OF THE DRAWINGS

FIG. 1 is a diagrammatic illustration of an apparatus according to an embodiment of the invention;

FIG. 2 is a diagrammatic illustration of a nozzle included in an apparatus according to an embodiment of the invention;

FIG. 3 is a diagrammatic illustration of a nozzle and fiber formation according to an embodiment of the invention;

FIG. 4 is a graph illustrating results of an energy dispersive x-ray chemical analysis on a fiber formed according to an inventive process;

FIG. 5 is a graph of results of Raman spectroscopy on a fiber formed according to an inventive process;

FIG. 6 is a graph of results of Raman spectroscopy on a fiber formed according to an inventive process; and

FIG. 7 is a graph of results of Raman spectroscopy on a fiber formed according to an inventive process.

### DETAILED DESCRIPTION OF THE INVENTION

Fibers of polymers such as polytetrafluoroethylene (PTFE) or polyaramids that have very high melt viscosities and/or exhibit orientational order and/or have ultra high molecular weights can exhibit exceptionally desirable materials properties such as extreme chemical inertness, ultra-high strength, resistance to degradation at high temperatures, biocompatibility, and superhydrophobic surface properties. These exceptional properties make the polymeric microfibers and nanofibers candidate materials for a host of applications, including smart fabrics, filtration materials, semi-permeable membranes, bioimplants, high strength fabrics and ropes, high strength microcomposites and nanocomposites and many others. Furthermore, as the fiber diameter is decreased to nanoscale dimensions, the lengths and hydrodynamic diameters of the polymer constituents become similar to the cross section of the fiber itself. This can lead to even further improvements in properties such as strength, crystallinity, and surface area. Thus an even wider range of applications may arise for polymer fibers that have nanoscale dimensions.

The present invention discloses a facile method for fabricating polymeric fibers using a new “jet-blowing” technique. Existing, conventional melt-blowing approaches for fiber production typically utilize the Exxon nozzle design, described more fully in U.S. Pat. No. 3,849,241, hereby incorporated into the present application by reference. These techniques involve extrusion of a single phase molten polymer fiber which is “blown” and stretched by separate, nearby single phase gas jets such that fibers are formed externally. It is not possible to form fibers of a number of high melt viscosity polymers, such as PTFE, by such conventional melt blowing, in which a polymer extruded through an orifice is stretched outside it by a pair of nearly parallel impinging jets of gas, see R. L. Shambaugh, Industrial & Engineering Chemistry Research 27, 2363-2372, (1988).

In an embodiment of an inventive process, a polymeric fiber is formed in a jet blowing process wherein a mixture of gas and polymer is driven by pressure through a nozzle. In a preferred embodiment, a polymer fiber is formed inside the nozzle. In a highly preferred embodiment, a polymer fiber produced according to an inventive process has a diameter which is less than the outlet diameter of the nozzle. Fiber formation in an inventive process is accompanied by much higher shear rates than are otherwise possible.

There are considerable environmental advantages to the present method since non-toxic, relatively chemically inert gases can be used as the agents to form and carry the polymer fibers. For example, nitrogen is not thought of as a suitable fluid for processing polymers, but has many advantages in terms of cost and environmental friendliness, as it can be generated on-site from the atmosphere. Thus, in a process according to the present invention, lower amounts of environmentally deleterious solvents or other chemicals are used, and in many cases virtually eliminated.

Apparatus for Jet Blowing

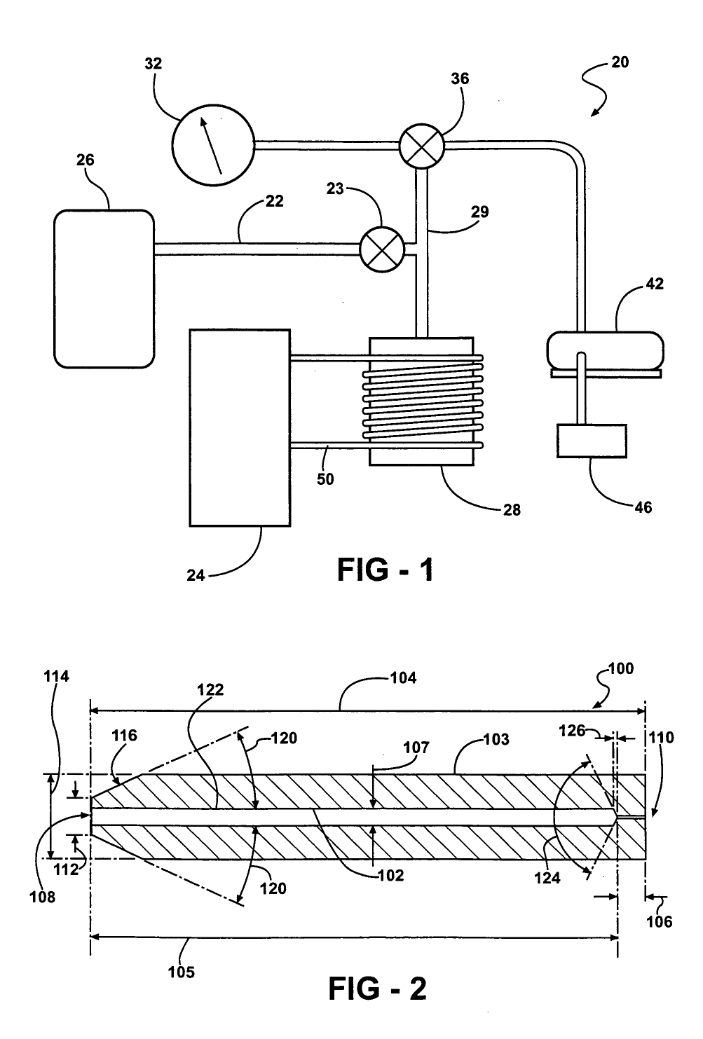

In one embodiment, an inventive apparatus for producing a polymer fiber is provided which includes a nozzle, and a gas source for providing a high pressure gas. FIG. 1 shows a schematic of an exemplary configuration for an inventive jet-blowing apparatus 20, including a nozzle 28 with attached tubing 22 and 29 connected to a gas source: a compressor 42 and contained gas 46. A valve 36 for controlling entry of gas into tubing 29 is depicted, along with a pressure gauge 32.

Further shown is an optional heating element 50 in contact with the nozzle 28 and an optional temperature controller 24. In a preferred embodiment, a heating element heats a polymer to a desired temperature. A heating element included in an inventive apparatus is preferably disposed in thermally conductive contact with one or more portions of the apparatus. For example, a heating element may be in contact with an optional reservoir, a polymer feed tube, a gas feed tube and/or a nozzle. A heating element is illustratively a coiled heating element, film heating element, induction heating element, or cartridge heating element. A heating element is preferably coupled to a power source (not shown) to provide power to heat the heating element. A heating element is optionally connected to a temperature controller in order to control polymer heating. A heating element included in an inventive apparatus is illustratively an electrical tape.

Further depicted is an optional feed tube 22 for delivery of polymer, along with an optional valve for controlling delivery of polymer. Also shown is an optional reservoir 26 for holding polymer to be delivered into the feed tube 22. A delivery device, such as a pump or feed screw (not shown) may also be included for moving polymer to a desired location in an inventive apparatus. In addition, two or more reservoirs, along with valves and feed tubes may be included. For example, where a composite polymer/polymer, polymer/ceramic, polymer/organic or polymer/metal material is desired, the starting materials may be mixed in a single reservoir or delivered separately from multiple reservoirs to a connecting tube or bore.

In operation, a polymer is brought into contact with the gas in the nozzle such that polymer fibers are produced and ejected from the nozzle. For example, a polymer is placed in tube 29 or nozzle 28. The polymer is optionally heated in the tube or nozzle. Pressurized gas is then brought into contact with the polymer, such as by opening valve 36, forming a gas/polymer mixture. Polymer fibers are delivered through the nozzle 28.

The nozzle includes a body having a bore defined therethrough as well as an inlet aperture and an outlet aperture. The bore further defines a first segment proximal to the inlet aperture and a second segment proximal to the outlet aperture. The first segment has a first diameter whereas the second segment has a second diameter, the first and second diameters differing in dimension. To accommodate the change in dimension of diameter between the first and second segments, the bore optionally includes a transition region between the first segment and the second segment. The diameter in the transition region illustratively tapers along the length between the first and second segments, though other configurations are operable.

In an embodiment of the inventive apparatus the diameter of the first segment has a distance across a widest dimension ranging from 6.0-0.01 inches, inclusive. A preferred first segment diameter ranges from 0.125 to 0.025 inches, inclusive. In general, a preferred diameter of the first segment ranges from 0.1 to 0.05 inches, inclusive.

The diameter of the second segment, also referred to as the second diameter herein, typically has a distance across a widest dimension ranging from 100 nanometers to 10 millimeters, inclusive. In a preferred embodiment, the second diameter ranges between 250 nanometers and 1 millimeter, inclusive. Further preferably the second diameter ranges from 500 nanometers to 300 microns, inclusive. Also preferred is an embodiment in which the second diameter ranges from 5 microns to 200 microns, inclusive and an embodiment where the second diameter ranges from 25 microns to 150 microns, inclusive.

The ratio of the first diameter to the second diameter preferably ranges between 2:1-1000:1, inclusive. The ratio of the first diameter to the second diameter further preferably ranges between 8:1-65:1, inclusive. In a further preferred embodiment, the ratio of the first diameter to the second diameter preferably ranges between 15:1-35:1, inclusive. Also preferred is a ratio in the range of 24:1-26:1, inclusive.

The nozzle bore is configured such that the inlet, outlet and length of the bore have a particular shape. For example, a preferred shape is a bore having a round shape in cross section at any point along the length of the bore, including at the inlet and outlet. Optionally, the cross-sectional shape of the bore is oval, slot shaped, triangular, semi-circular, rectangular, or other suitable shape. Further, the first segment of the bore may have one cross-sectional shape while the cross-sectional shape of the second segment has a second cross-sectional shape. Such bore configurations are made by electrical discharge machining (EDM) or other methods.

In one embodiment, the lengths of the first and second segments are unequal. The length of the first segment typically ranges between 1-10 inches, however, other lengths are suitable.

The second segment typically has a length ranging from 0.01 millimeter to 1 meter, inclusive. In a preferred embodiment, the second segment has a length ranging from 0.5 millimeters to 1 centimeter, inclusive. However, as for the first segment, other lengths are suitable.

FIG. 2 illustrates an exemplary nozzle 100. The nozzle includes a body 103 having a bore 102 therethrough. The bore has a total length 104, a first segment 105 and a second segment 106. The diameter of the first segment is illustrated at 107. The bore inlet is depicted at 108 and the outlet at 110. In addition, connecting tubing (not shown) having an inner diameter is shown at 112 and a connector (not shown) having an inner diameter is shown at 114. In this example, the body 103 is shown having a frustroconically shaped inlet end 116, however the shape of the inlet end is not considered a critical aspect of the invention and other shapes are suitable. The inlet end may be shaped or patterned to interact with connecting tubing and a connector, for instance including a thread (not shown). An angle 120 is defined by the shaped inlet end and a wall of the first bore segment 122. In the illustrated embodiment, the angle 120 is 59°. An optional transition region 126 is illustrated between the first segment 105 and the second segment 106. Further illustrated is an angle 124 formed by the walls of the transition region 126. In this example, the angle 124 is 120°, however the angle is not considered a critical aspect of the invention and other angles are suitable.

A polymer is disposed in an inventive apparatus for producing a polymer fiber. The polymer is preferably disposed in the coupler connecting a gas source to the nozzle such as connecting tubing, or in the bore of the apparatus. Further preferred is disposition of a polymer/gas mixture in the apparatus and in particular a two phase mixture of gas and polymer.

A gas source delivers gas at a pressure ranging from 50 psi-150,000 psi, inclusive. In a further embodiment, gas is delivered at pressures ranging from 100 psi to 100,000 psi, inclusive. In a preferred embodiment, gas is delivered at pressures ranging between 300 psi and 30,000 psi, inclusive.

The gas source is illustratively a compressor. An inventive apparatus optionally includes a valve operative to control the gas source, such as a compressor. In a further option, a pressure gauge is included to indicate the pressure of the gas.

In one embodiment, pressure is applied using a pump, such as a Newport Scientifc 30,000 PSI two-stage pneumatic pump. This pump has sufficient capacity to maintain the pressure in excess of 6000 psi during jet blowing through the nozzle. In such an embodiment, pressure is not regulated, but rather increased until jet blowing occurred. Particular examples detailed herein describe pressures applied until jet blowing occurs which are in the range of 6000 to 10000 psi.

An inventive apparatus is constructed to accommodate the high pressures developed in operation. For example, a coupler such as connecting tubing and connectors are standard high pressure fittings and equipment such as are known in the art and commercially available, for instance, from High Pressure Equipment Co., Erie Pa. (HIP, Inc.). Further, the tubing, connector and nozzle are preferably substantially inert with respect to the polymer. For example, the nozzle is attached to 1/4 inch ID 40,000 PSI high pressure tubing, commercially available from HIP Inc., that contains a polymer of interest for forming fibers. The nozzle body may be made of a material resistant to oxidation in a preferred embodiment, for instance using type 316 stainless steel.

An additional dimension of the apparatus is the distance from the bore wall 122 to the outer wall of the body. This distance is also sized to accommodate pressures achieved in the bore.

Process of Producing Fibers

In one embodiment, an inventive jet blowing process for producing a polymer fiber includes the steps of providing a mixture of a polymer and a gas; and blowing the mixture of a polymer and a gas through a nozzle which has an outlet aperture. The process produces a polymer fiber having a diameter less than the diameter of the outlet aperture of the nozzle. In a preferred embodiment, the diameter of the fiber produced is in the range of 10 nanometers to 50 microns as described in further detail below.

In another embodiment, a process for producing a polymer fiber, the process including the steps of providing a polymer and introducing a flow of a gas, such as a pressurized gas, so as to create a flowing mixture of gas and polymer. A further step includes moving the mixture of gas and polymer through a passage having a constriction. For example, the passage may be a bore having an inlet aperture and an outlet aperture. The bore or passage having a first segment proximal to the inlet aperture having a first diameter, and a second segment proximal to the outlet aperture having a second diameter wherein the first diameter is substantially greater than the second diameter. Action of extensional forces on the polymer result formation of a polymer fiber, the fiber having a diameter smaller than the second diameter.

In a further embodiment, an inventive jet blowing process for producing a polymer fiber includes the step of providing an apparatus as described herein. A further step in an inventive process includes placing a polymer in the apparatus such that high pressure gas from the gas source maybe brought into contact with the polymer. For example, polymer is placed in a tube or container connected to the nozzle such that high pressure gas may be brought into contact with the polymer. Referring to FIG. 2 for example, polymer may be disposed in connecting tube 29. Further, polymer may be disposed in the nozzle bore.

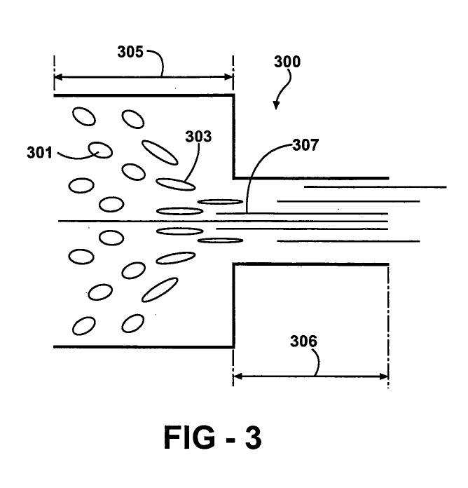

FIG. 3 schematically depicts another embodiment of a nozzle used in an inventive process. Illustrated is a first segment 305 and a second segment 306. In this embodiment no transition region is present between the first and second segments. Shown is the axisymmetric contraction of the jet blowing nozzle bore at the junction between first segment 305 and second segment 306. The sphere-like shapes 301 and oval-like shapes 303 schematically represent the shapes of polymer particles. In contrast to extrusion techniques in which the diameter of the extruded material is substantially equal to the diameter of the outlet, a fiber 307 is formed in an inventive process which has a diameter less than the diameter of the first and second segments. In a preferred embodiment, multiple fibers having a diameter smaller than the outlet diameter are formed. In a further preferred embodiment, one or more polymer fibers are formed inside the nozzle. Thus, many fibers may be formed nearly simultaneously, leading to increased production of fibers.

Polymers used in an inventive process include those typically processed by conventional fiber production techniques such as melt processing techniques. In an additional preferred embodiment, a process according to the present invention produces a fiber from a polymer not typically amenable to conventional techniques, that is, those not typically considered melt processible. Non-melt processible polymers include fluoropolymers such as PTFE and others such as are set forth in Fluoroplastics, Volume 1: Non-Melt Processible Fluoroplastics, Ebnesajjad, Plastics Design Library, Norwich, N.Y. 2000. Thus, for example, an inventive process is particularly advantageous in producing fibers from polymers having a high melt viscosity. A polymer having a viscosity of approximately 1×10⁷ poise or greater at a viable processing temperature is considered to have a high melt viscosity and be non-melt processible. A difficulty in processing polymers having a high melt viscosity is the tendency of such polymers to degrade at temperatures required to process them by traditional techniques. Thus, a “viable processing temperature” is one at which the polymer does not substantially degrade.

An inventive process is further applicable to a polymer exhibiting orientational order. In addition, an inventive method is particularly advantageous where a polymer fiber is to be produced and the polymer is a very high molecular weight polymer, such as a polymer having a molecular weight greater than 1×10⁶ g/mol.

In general, polymers from which fibers are produced according to an inventive process include organic polymers illustratively including polyacrylonitrile, polyolefins, cellulose acetates, cellulose nitrites, fluoropolymers, polyamides, polyimides, polystyrene, polysulfone, polyarylamides, polybutadienes, polybutenes, polycarbonates, polyesters, polyethylene, polypropylenes, polyvinyl acetates, polyurethanes, acrylates, methacrylates, polyvinylidene chlorides, silicones, styrenes, copolymers such as ethylene-methacrylic acid copolymers, ethylene-vinyl acetate copolymers, polyvinylacetate-methacrylic copolymers and the like.

Further non-limiting examples of polymers from which fibers are produced according to an inventive method include polytetrafluoroethylene (PTFE), both ultrahigh molecular weight (e.g., Teflon 7A) and low molecular weight (e.g., 3M Dyneon TF9201); a polyaramide; and polymethylmethacrylate (PMMA). The ultra high molecular weight PTFE and similar ultra high melt viscosity polymers are of particular interest because there is no other known method for so easily processing them.

The polymer provided in an inventive process may include a polymer blend, a mixture of polymer and an inorganic material composites and a mixture of a polymer and an organic material to form a fiber according to the invention. Thus, a fiber produced according to the invention is optionally a polymer/polymer composite, a polymer/inorganic composite a polymer/organic composite or a combination of these. For example, a mixture of a melt-processible and a non-melt processible polymer may be used as a starting polymer material in an inventive process.

An additional advantage of an inventive method is that it allows for facile fabrication of composites formed by mixing a precursor powder or solution with the polymer to be jet blown. A precursor describes a material which is transformed during processing such that a component of the precursor is incorporated into the fiber produced by an inventive process. For example, an exemplary polymer/inorganic composite includes a transition metal such as iron or tungsten and a polymer, such as PTFE. Such a composite is readily formed, for example, by mixing a precursor such as iron acetate into the PTFE powder and jet blowing. Upon jet blowing microscale or nanoscale particles of iron are incorporated into a fiber containing PTFE. Such a composite is advantageously used in catalytic applications. Other polymer/polymer, polymer/ceramic, polymer/organic and polymer/metal composites are readily formed.

A polymer mass used to form fibers in an inventive process includes a solid polymer mass in a preferred embodiment. For example, a polymer mass used to produce a fiber according to an inventive process is generally a particle, powder or pellet form. Individual pellets or granules may fuse in an inventive process to form a polymer larger than the granules of the starting material. Further, individual granules may break into smaller particles, such as by application of the gas. For polymers with very high melt viscosities, a fine powder which flows more easily than bulk material is a preferred form of polymer mass. Thus, in a preferred embodiment, a solid polymer is processed without addition of liquid.

In a further embodiment, a liquid solvent, softener or the like may be added to the polymer mass as described in more detail below.

A component of a polymer mass is preferably present in the polymer fiber produced. However, optionally, a component of a polymer mass, such as a solvent, may be substantially absent or reduced in the fiber produced. Further, where a precursor is present in the polymer starting material mass, an element of the precursor is not substantially present in the produced fiber, as described in some examples herein.

For melt-processible polymers, a solid, a liquid or semi-solid polymer may be used as a polymer starting material in producing a fiber according to an inventive process. Further, a mixture of a solid polymer, ceramic or metal and a liquid or semi-solid polymer, ceramic or metal may be used in forming a composite. In addition, a precursor may be included as described above.

In one embodiment of the invention, a bioactive agent can be incorporated during jet-blowing to produce a pharmaceutical delivery device for the bioactive agent. For example, a bioactive agent includes compounds such as an analgesic, an antiallergic, an antiarrhythmic, an antibiotic, an anticonvulsant, an antidepressant, an antifungal, an antihypertensive, an anti-inflammatory agent, an antineoplastic, an antitumor agent, an anti-ulcer agent, an antiviral, an anxiolytic, a bronchodilator, a hypoglycemic, a metastasis inhibitor, a muscle relaxant, a sedative and a tranquilizer compound. Remington's Pharmaceutical Sciences, 16th Ed., 1980, Mack Publishing Co., Easton, Pa. and in Goodman and Gilman's The Pharmacological Basis of Therapeutics by Hardman and Limbird, 9th Ed., 1996, McGraw-Hill, New York and in The Merck Index: an encyclopedia of chemicals, drugs, and biologicals, 12th Edition, 1996, Merck & Co., Whitehouse Station, N.J.

A further step in an inventive process is activating a gas source such that a polymer fiber is produced. The step of activating a gas source includes an action such as opening a valve in connection with connecting tubing and/or nozzle such that gas is introduced into the connecting tubing and/or nozzle and contacts the polymer. Generally polymer fibers are produced using pressures ranging from about 50 to about 150,000 psi. In a preferred embodiment, gas is delivered at pressures ranging from 100 psi to 100,000 psi, inclusive. In another preferred embodiment, gas is delivered at pressures ranging between 300 psi and 30,000 psi, inclusive. Maximum pressure range is determined by a number of factors, including the size of the outlet. Another factor is the pumping capacity of a pump where such is used as a source of gas. For example, using a nozzle having a 20 micron outlet, the upper pressure limit is about 30,000 psi for a Newport-Scientific two-stage 30,000 psi pump. This pump has sufficient capacity to maintain the pressure in excess of 6000 psi during jet blowing through the nozzle. In one embodiment, pressure is not regulated, but rather increased until jet blowing occurred. Particular examples detailed herein describe pressures applied until jet blowing occurs which are in the range of 6000 to 10000 psi.

Dissolved gas plasticizes and softens the polymer and facilitates fiber formation. In the case of a non-melt processible polymer, PTFE, the solubility of nitrogen in the amorphous and crystalline regions of PTFE may be different and the solubility is even higher at temperatures in the range used for jet blowing.

An inventive composition includes a gas inert with respect to the polymer, the gas present in a concentration ranging from 0.1-40%, by weight, inclusive. A preferred composition includes a gas at a concentration in the range of 0.25-15% by weight, inclusive. A further preferred composition includes a gas at a concentration in the range of 0.5-10% by weight, inclusive. Exemplary suitable gases include nitrogen, argon, neon, air, SF₆, helium, CF₄, H₂, steam, supercritical H₂O, C₁-C₃ fluorinated hydrocarbon gas such as CH₂F₂, and C₁-C₃ hydrocarbon gases such as methane. Particularly preferred is nitrogen. Also preferred is argon. In some embodiments, carbon dioxide may be used.

In particular, an inventive composition includes a polymer, other than PTFE, and nitrogen in a concentration ranging from 0.1-3.5%, by weight, inclusive. Another preferred composition includes a polymer, such as a fluoropolymer or other polymer, and nitrogen, the nitrogen present in a concentration ranging from greater than 3.5% to 40%, by weight, inclusive. Particularly preferred is a composition including PTFE and nitrogen, the nitrogen present in a concentration ranging from greater than 3.5% to 40%, by weight, inclusive. Further preferred is a composition including a polymer, such as PTFE, and nitrogen, the nitrogen present in a concentration ranging from 4.0-10%, by weight, inclusive.

Additionally, an inventive composition includes a polymer and argon, the argon present in a concentration ranging from 0.1-40%, by weight, inclusive. A preferred composition includes a polymer and argon, the argon present in a concentration ranging from greater than 0.25% to 25%, by weight, inclusive. Further preferred is a composition including a polymer and argon, the argon present in a concentration ranging from 0.5-10%, by weight, inclusive.

The identity of the gas used in an inventive process and its solubility in a particular polymer affects the jet blowing process. For example, the solubility of helium in PTFE at 67° C. and 51 MPa is approximately 0.4 wt % (Briscoe, 1986, supra), about the same on a molar basis as that of dinitrogen. When helium is used for jet blowing at 310° C., the ratio of fibers produced to particles produced decreases. Where nitrogen is used, the fibrous fraction is nearly 100%. Furthermore, the proportion of fibrous PTFE produced when carbon dioxide is used for jet blowing at 310° C. is also less than with nitrogen or argon.

An optional step in an inventive process is that of heating the polymer. Microfibers and nanofibers of polymers are obtained over a wide temperature range depending on the polymer of interest. Generally, fibers are obtained at temperatures ranging from subambient to about 500° C. Ambient temperature generally ranges from about 20-25° C. and the term “subambient” refers to temperatures below this range, generally ranging from about −20° C. to about 20° C. In a preferred embodiment, subambient temperatures are in the range of 10° C.-20° C. The selection of an appropriate temperature depends upon the softening point of the polymer as well as other factors. For instance, a temperature range of 110-300° C. is suitable for melting polyethylene and does not cause decomposition. Additionally, if a soft polymer such as silicone or a polyacrylate is employed, subambient temperatures are appropriate.

For polymers such as PTFE that exhibit high melt viscosities, higher temperatures are often required. PTFE fibers, for example, are formed in the temperature range of about 300° C. to 380° C. from PTFE powder loaded into an apparatus.

Advantageously, a polymer is optionally and preferably heated to a temperature below its melting point in an inventive process. For example, in processing PTFE the pressure required to deposit fibers decreases from approximately 100 MPa at 260° C. to 13 MPa at 360° C. Thus, jet blowing of fibers is possible at temperatures much below the melting point of virgin PTFE 7A, which is 340° C. at 0.1 MPa.

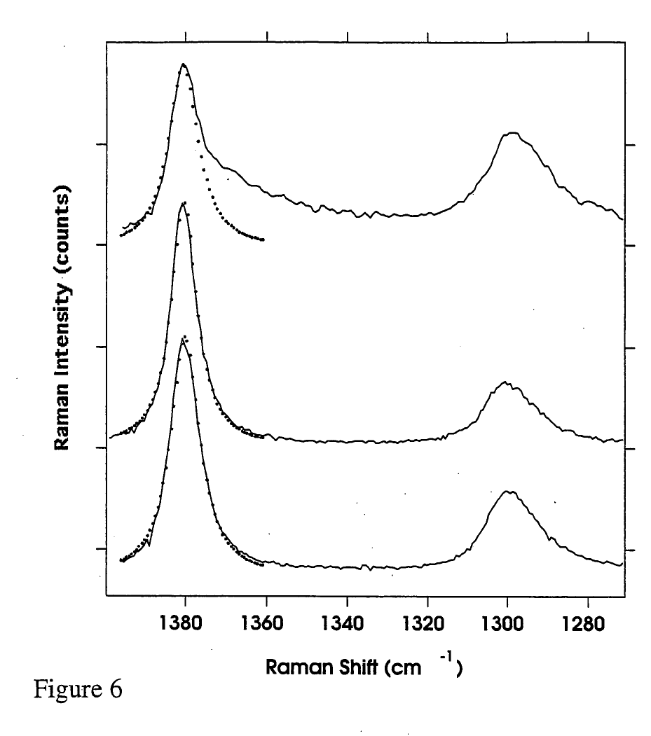

Like many other forms of PTFE, granular 7A starting material that has been melted even once exhibits changes in physical structure that result in a low frequency tailing of the 1381 cm⁻¹ symmetric CF₂ stretching mode in the Raman spectrum (FIG. 6) and a lowered melting point of approximately 326° C. upon subsequent melting. Dupont Teflon PTFE 7A Granular Compression Molding Resin Product Information, (http://www.teflon.com/Teflon/downloads/pdf/h61664-1.pdf); R. J. Lehnert, P. J. Hendra, N. Everall, Polymer 0.36, 2473-76 (1995); R. J. Lehnert, P. J. Hendra, N. Everall, N.J. Clayden, Polymer 38, 1521-1535 (1997). FIG. 6 illustrates that these features are not observed in the jet blown fibers processed at temperatures below the melting point. Fibers processed below the melting point exhibit micro-Raman spectra as illustrated in FIG. 6. FIG. 6 shows spectra at 0.1 MPa and 20° C. of virgin PTFE 7a in the lower trace, a jet blown PTFE7A fiber in the middle trace, and PTFE7A that has been melted once by heating above 340° C. and then solidified in the top trace. Dots adjacent to the traces are indicative of a lorentzian fit to the 1381 cm⁻¹ mode. Only PTFE that has been melted exhibits the low frequency tailing of 1381 cm⁻¹ mode associated with reduced crystallinity and melts at 326° C. according to DSC. No difference is observed between the modes of virgin PTFE7A and jet blown PTFE, which are also identical throughout the rest of the Raman spectrum. Spectra were collected on individual PTFE fibers with a Dilor XY micro-Raman spectrometer. 514 nm excitation at a power of less than 1 mW was used. Melting points were determined via differential scanning calorimetry (DSC). A heating rate of 5° C./min was used. It is apparent that their physical structure has not been changed in the manner associated with melting. A melting point of 340° C. and especially the absence of the tailing of the 1381 cm⁻¹ Raman mode and are signatures of PTFE that has never been melted before (see references S. Ebnesajjad, supra; Dupont Teflon PTFE 7A Information, supra, and Lehnert et al., supra, 1995 and 1997).

It is unexpected to find that it is possible to process PTFE by jet blowing without melting. For many polymers it would not be surprising to find that deformation and flow can occur below the melting point. The majority of polymers consist of crystals embedded in an amorphous phase (F. W. Billmeyer, Textbook of Polymer Science (Wiley, New York, ed. 3rd, 1984). When the amorphous phase is above its glass transition temperature deformation and flow can occur more readily. It is surprising that ultra-high molecular weight PTFE forms into fibers within the jet at temperatures so far below its melting point while not melting. Even above its melting point when none of the polymer is crystalline, the viscosity of PTFE is so high (˜10¹⁰ to 10¹² poise) that it is usually considered to be non-melt processible. Below its melting point, it tends to be largely crystalline (S. Ebnesajj ad, supra), and remains so after jet blowing, as evidenced by the Raman scattering data described. This highly crystalline ultra high molecular weight polymer would ordinarily be expected to have a high shear modulus and be very difficult to process. In contrast, in processing of macroscale PTFE structures with supercritical carbon dioxide, melting occurs, as evidenced by a product that exhibits the lowered melting point of approximately 326° C. M. Garcia-Leiner, A. J. Lesser, Annual Technical Conference—Society of plastics Engineers 61, 1610-1614 (2003); Y. Ohsaka, K. Wynne, S. Shenoy, S. Irie, PCT Int. Appl. 2003035750 (2003).

PTFE fibers produced according to one embodiment of an inventive process, as described above, have a melting point after processing substantially similar to that of the starting material, indicating that they have not been decomposed or chemically altered. Thus, one embodiment of the present invention is a fiber having a melting temperature indicative of a non-melted polymer. For example, a preferred embodiment of an inventive fiber is a PTFE fiber having a melting temperature above 335° C.

The ability to process without melting affords advantages such as additional control over the PTFE microstructure, crystallinity, and degree and type of expansion and the avoidance of decomposition, which has been identified as a source of halogenated organic acids that are environmentally deleterious in even very small concentrations. D. A. Ellis, S. A. Mabury, J. W. Martin, D. C. G. Muir, Nature 412, 321-324 (2001).

In an embodiment of an inventive process, jet blowing is performed by spraying a two-phase mixture of gas and solid polymer at elevated temperature and pressure through a single small aperture, the outlet of the nozzle bore. Behind the outlet, the flowing high pressure gas and polymer mix in the part of the bore that is larger in diameter, the first segment. In a preferred embodiment there is an approximately 25:1 axisymmetric contraction between the first segment and the second segment. The flow driven through this abrupt contraction at the entrance of the second segment by the large pressure drop has strong extensional and shear components, which result in deformation, extension, and reorientation of the polymer chains to form fibers.

Illustrating an inventive process in operation, the high pressure gas, optionally at high temperature, blows a two phase polymer/gas mixture from the tubing into the nozzle. The polymer/gas mixture exits the nozzle in the form of a jet and polymer fibers form during this jet-blowing process. These fibers are, for instance, collected and coated on a surface of choice. For polymers that are processed at temperatures sufficiently high to cause oxidation, or where the fibers are otherwise subject to oxidative processes, the fibers are optionally jet blown into an inert atmosphere of a gas such as nitrogen. Further optionally, a slow flow of inert gas oriented such that the slow flow of inert gas contacts a produced polymer fiber is included to inhibit oxidation of the polymer and any resulting clogging of the outlet. A wide range of surfaces may be readily coated in a conformal manner with fibers of polymers such as PTFE by this method.

Solution Blowing of Polymer Fibers

In an embodiment of an inventive process, a polymer solution is used rather than or in addition to a polymer solid as starting material for jet blowing production of fibers. The solution or slurry is heated to a desired temperature in the range of subambient to about 500° C. High pressure gas or fluid is then applied to the polymer, and microfibers or nanofibers are sprayed out through the outlet together with the jet of gas and fluid.

For example, a PMMA/chloroform solution is sprayed from a nozzle having a 50 micron outlet at a pressure of 10,000 psi and a temperature of 21° C. Fibers are obtained by this process having diameters ranging from submicrons, to a few microns, and up to hundreds of microns in length.

A solvent, including a supercritical fluid, or a plasticizer may be added to the polymeric material to facilitate the process. The appropriate choice depends upon the specific polymer employed.

Properties of Polymer Fibers

A variety of microfibers and nanofibers can be obtained using an inventive process, including fibers having a diameter ranging from 50 nanometers to 50 microns and lengths ranging from several nanometers to several centimeters. In particular embodiments, fibers having lengths ranging from 100 nanometers to 4 millimeters are produced. In further embodiments, fiber having lengths in the range of meters to several kilometers may be produced. As described herein fibers from various polymers are produced according to an inventive process.

In an embodiment of an inventive process, fibers obtained from a nozzle outlet have a size distribution ranging from a few hundred nanometers to a few microns in diameter. In a further embodiment, using a particular gas/polymer mix at a particular temperature and varying the outlet diameter, as the outlet size decreases, the proportion of smaller diameter fibers increases.

PTFE fibers produced by the jet blowing technique have complex structure on many different length scales and different morphologies depending on processing conditions. The fibers have overall diameters in the micron to submicron range as detailed herein, and individual fibers typically exhibit further nanostructure.

In an embodiment of an inventive process, fibers are expanded and include interconnected “nodes” separated by nanoscale fibrils. The degree of expansion and amount of porosity can be varied widely by changing the processing conditions. The expanded fibers exhibiting semi-permeability and other properties characteristic of expanded PTFE (see S. Ebnesajjad, supra), making them of interest for a wide range of applications.

In further embodiments of the process, relatively uniform nanopores are achieved.

In addition, fibers are obtained in an embodiment of an inventive process which include multiple nearly linear nanoscale fibrils, and which exhibit high surface area.

Variation of the morphology and molecular weight of the starting material allows for additional control over the size and morphology of the jet blown fibers. Granular PTFE powder is not noted for its ability to fibrillate and is not usually used for the fabrication of expanded PTFE (see S. Ebnesajjad, supra). Thus, the jet blowing process produces the surprising capacity for PTFE and similar polymers to fibrillate. “Fine powder” PTFE resins, see S. Ebnesajjad, supra, are typically used for fabrication of expanded PTFE because they have a much stronger tendency to fibrillate than granular powder. An inventive process for fiber formation achieves fiber formation from DuPont 601A fine powder PTFE Dupont Teflon PTFE 601A Fine Powder Lubricated Extrusion Resin (http://www.teflon.com/Teflon/downloads/pdf/h61664-1.pdf). This material has a molecular weight that is somewhat less than that of ultra-high molecular weight 7A granular powder, but still cannot be processed by conventional techniques. The fibers formed from 601A starting material are straighter and more uniform in diameter than the fibers formed from PTFE 7A. Some fibers produced by an inventive process also have a different morphology, including relatively uniform nanoscale nodules that are fused together or interconnected by fibrils. These fibers are semi-permeable and exhibit extremely high surface area.

PTFE fibers readily adhere to substrates such as silicon or glass. The fibers adhere strongly enough to substrates such as glass and silicon such that they will not dislodge under normal handling in air or if the substrate is sharply rapped on its side or upside down. Bonding techniques involving, for example, active metal surfaces or lower melting fluoropolymer interlayers are optionally used to adhere fibers to a surface.

PTFE is intrinsically hydrophobic and jet blown fibers are even more hydrophobic. Such enhanced hydrophobicity is termed superhydrophobicity. (L. Feng et al., Adv. Mater. 14, 1857-1860 (2002)). Thus jet blowing allows for single step fabrication of highly hydrophobic surfaces that exhibit extreme chemical inertness.

Articles

A polymeric material produced according to an inventive process is useful in various applications including, but not limited to, manufacture of articles having a polymer coating. For example, a material produced according to an inventive process is advantageously used to coat a surface or pattern a surface of a medical device or medical implant. In particular, such a coating or patterned surface inhibits cell adhesion and growth on the device or implant. For instance, inhibition of growth of patient cells or bacteria on an implant is highly advantageous in reducing risk of adverse reaction and infection.

In addition, a fiber or material produced according to the invention is useful in any application where polymer fibers, materials and composites are traditionally used, such as in fabrics and textiles, since the inventive process allows greater yields at lower cost.

An advantage of an inventive process is that output fibers can be directly jet blown onto a desired surface. Thus, for instance, inventive fibers may be jet blown onto a screen or framework to produce a semi-permeable membrane or filter. In another embodiment, fibers may be jet blown onto a surface or into a mold and later removed to serve as a semi-permeable membrane in the form of a sheet material for instance.

Further, the method avoids use and production of environmentally detrimental substances, such as haloacids. For instance, the present process allows for processing of PTFE at temperatures in the range of 380° C. down to less than 300° C., considerably below the melting point. The ability to process PTFE as such low temperatures is an advantage because temperatures of 360° C. and above have been shown to induce thermolysis in PTFE that leads to the formation of environmentally deleterious organic haloacids. (D. A. Ellis, S. A. Mabury, J. W. Martin, D. C. G. Muir, Nature 412, 321-324 (2001).

### EXAMPLES

### Example 1

Materials: Polyethylene (melt index=36) and poly(methyl methacrylate) (average Mw, 120,000) are purchased from Aldrich. PTFE powder in ultra high molecular weight (Dupont TeflonTM 7A) form is obtained from Polysciences, Inc. Low molecular weight PTFE (Dyneon TF9021) is obtained from 3M.

### Example 2

Characterization: Scanning electron micrographs are obtained on a JSM 5400 instrument and also a JEOL 6700F. Differential scanning calorimetry thermal analyses are obtained with a TA Instruments SDT2960 at heating rate of 10° C./min under argon atmosphere. Raman spectra are collected on individual fibers by means of a Dilor XY micro-Raman spectrometer with 514 nm laser excitation.

### Example 3

Using either nitrogen or argon, DuPont Teflon 7A PTFE, an ultra high molecular weight granular powder with an average particle size of 35 microns S. (Ebnesajjad, Fluoroplastics, Volume 1: Non-Melt Processible Fluoroplastics (Plastics Design Library, Norwich, N.Y., 2000), Dupont Teflon PTFE 7A Granular Compression Molding Resin Product Information (http://www.teflon.com/Teflon/downloads/pdf/h61664-1.pdf) is jet blown into fibers as long as 500 microns. The fibers are jet blown into an inert atmosphere that is exhausted into a fume hood.

### Example 4

Polyethylene

In one example, polyethylene (PE) fibers are jet blown with nozzles having a second segment length of Imillimeter and a 150 micron outlet diameter, a 50 micron outlet diameter, and a 20 micron outlet diameter, respectively, at a temperature of approximately 150° C. A pump is used as a gas source and pressure applied until jet blowing occurred with the specified nozzle.

In some cases the fibers form bundles and a web-like structure. A fiber having a diameter of about half a micron is obtained from a nozzle having a 150 micron outlet diameter, while a fiber having a diameter of about 150 nanometers is obtained from the 50 micron outlet diameter nozzle. Micro Raman spectra collected on individual fibers reveal them to be crystalline PE.

The contact angle of water on a glass surface coated with polyethylene fibers is measured to be 137°. The typical contact angle of water on pure polyethylene is known to be 96°, while the contact angle on clean glass is 0°. The increase in the contact angle is attributed to the roughness of the polymer nanofiber web, which includes fiber and air. Increases in roughness results in a more hydrophobic surface (Feng, L. et al. Angew. Chem. Int. Ed. 2002, 41, 1221). To this end, a jet-blowing process of the present invention provides an easy way of coating surfaces to render them highly hydrophobic. Such highly hydrophobic surfaces have superior fluid flow properties and exhibit decreased drag.

### Example 5

Polymethylmethacrylate (PMMA)

In this example, PMMA nanofibers are formed from a nozzle having a second segment length of 1 millimeter and a 50 micron outlet diameter at a temperature of approximately 110° C. A pump is used as a gas source and pressure applied until jet blowing occurred with the specified nozzle. A fiber having a diameter of about 500 nanometers is produced.

### Example 6

In this example PTFE microfibers and nanofibers are jet blown from a nozzle having a 1 millmeter second segment and a 50 micron outlet. A pump is used as a gas source and pressure applied until jet blowing occurred with the specified nozzle.

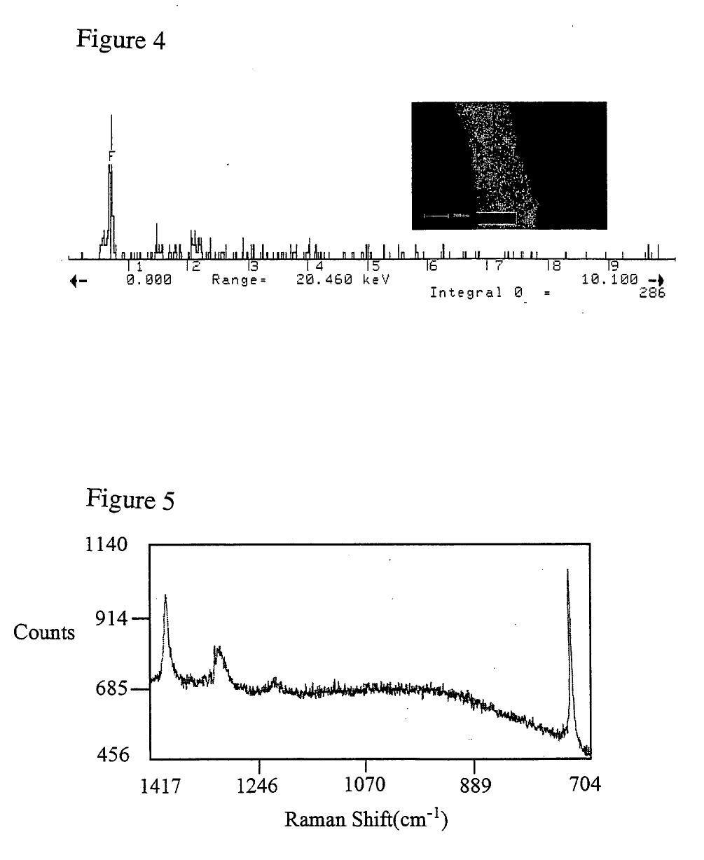

Energy dispersive x-ray chemical analysis (EDAX) results on PTFE fibers formed from Teflon 7A (FIG. 4) exhibit strong fluorine peaks similar to those seen in the starting material, confirming that the observed fibers are PTFE. The inset picture shows the fiber where EDAX is collected. FIG. 5 shows Raman spectra collected on individual PTFE fibers formed from Teflon 7A exhibit highly characteristic PTFE Raman peaks at 1383,1305,1222,736 cm⁻¹. The lack of a tail for the peak at 1383 cm⁻¹ indicates that the PTFE polymer fibers are still highly crystalline and that significant decomposition does not occur at the 310° C. temperature used for processing these fibers (see Lehnert, et al. Polymer, 1997, 38, 1521 and Lehnert, R. J.; et al. Polymer, 1995, 36, 2473). Differential scanning calorimetry analyses on fibers formed from both high molecular weight Teflon 7A and low molecular weight 3M Dyneon TF9201 show that the melting points of the fibers remain substantially similar to that of the starting materials, again providing strong evidence for the identification of the fibers as PTFE. See Table 1 below.

TABLE 1
Melting points of PTFE starting materials and jet blown fibers.

| Material | Melting temperature (° C.) |
|---|---|
| Teflon 7A ™ powder | 341.2 |
| Teflon 7A ™ fiber | 339.7 |
| Dyneon ™ 9201 powder | 325.7 |
| Dyneon ™ 9201 fiber | 324.3 |

### Example 7

Scanning electron microscopic (SEM) analysis of deposited PTFE fibers shows that the fraction of fibrous material deposited is very high.

### Example 8

An inventive process for fiber formation achieves fiber formation from DuPont 601A fine powder PTFE Dupont Teflon PTFE 601A Fine Powder Lubricated Extrusion Resin (http://www.teflon.com/Teflon/downloads/pdf/h61664-1.pdf). This material has a molecular weight that is somewhat less than that of ultra-high molecular weight 7A granular powder, but still cannot be processed by conventional techniques. The fibers formed from 601A starting material are straighter and more uniform in diameter than the fibers formed from PTFE 7A.

### Example 9

Fibers are jet blown from PTFE 601A fine powder starting material from DuPont. A 50 micron diameter nozzle having a second segment length of 1 millimeter is used at a temperature of approximately 310° C. This is below the melting point of PTFE, although fibers can also be formed above the melting point as well. A dense fibrous mat is formed composed of fibers approximately 1 micron in diameter, relatively straight and uniform, and up to several millimeters long. The mat readily adhered to substrates such as glass and silicon and could not be dislodged by sharp rapping of the substrate on its side. Raman spectroscopy confirmed that the fibers are principally crystalline PTFE and contained no impurities detectable by this technique. Differential scanning calorimetry revealed that the melting point is 340° C. Virgin PTFE 601A fine powder melts at 340° C. as well. After an initial melting PTFE 601 A fine powder subsequently melts at 326° C. Thus the melting point of 340° C. observed for the jet blown 601 A fibers indicates that they have not been processed in a manner associated with melting. If they had been melted at least once, a melting temperature of 326° C. might be expected. Comparison of the heats of melting for the virgin 601. A material and jet blown fibers indicates that the fibers retain approximately 70% of the crystallinity of the starting material. Raman spectroscopy further showed significant differences between mode intensities for spectra collected with the excitation laser polarization parallel and perpendicular to the fiber, indicating that the polymer chains are at least partially aligned along the length of the fibers. Water droplets placed upon the surface of jet blown PTFE 601A fibers exhibit a contact angle of 159°, much higher than the contact angle of a flat PTFE surface, which is 113°. C. W. Extrand, J. Colloid Interface Sci. 207, 11-19 (1998).

### Example 10

Fibers are jet blown from PTFE 7A granular resin from Dupont. This is an ultra high molecular weight dense resin. A 50 micron diameter nozzle is used at a temperature of approximately 310° C. Fibers could also be formed above the melting point. The range of fiber morphology and diameters is larger than for fibers formed from PTFE 601. Fiber diameters ranged from 150 nm to several microns. The fibrous mat consisted of fibers that are curled and interpenetrating to a larger extent than the PTFE 601 fibers. Raman spectroscopy confirmed the identity of the fibers as pure PTFE. Differential scanning calorimetry revealed that they had approximately 60 to 70% of the crystallinity of the starting material.

### Example 11

Fibers are jet blown from polycaprolactone at approximately 80° C., above the melting temperature of 60° C. Fibers ranging in diameter from submicron to several microns are formed. The fibers are relatively straight with only small amounts of curvature (minimum radii on the order of several tens of microns).

### Example 12

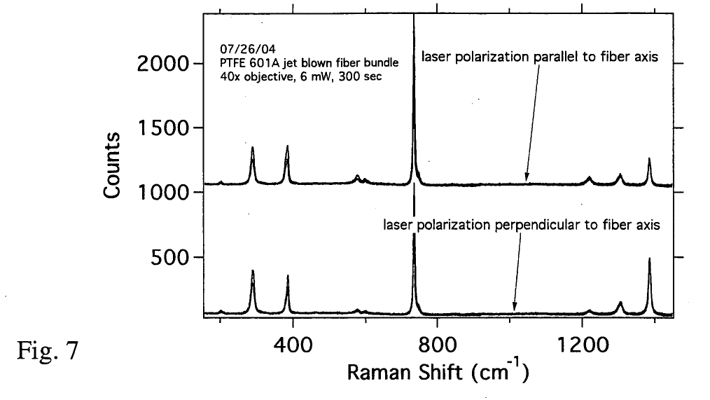

Polarized Raman spectroscopy is sensitive to the degree of chain orientation in a polymer fiber Citra, M. J., Chase, D. B., Ikeda, R. M. & Gardner, K. H. Molecular-Orientation of High-Density Polyethylene Fibers Characterized by Polarized Raman-Spectroscopy. Macromolecules 28, 4007-4012 (1995). FIG. 7 shows that Raman spectra of PTFE 601A fibers exhibit a substantial difference, note especially the pattern of the three peaks above 1200 cm⁻¹, depending on whether the polarization of the incident laser is parallel or perpendicular to the long axis of the fiber. This indicates that there is a similarly substantial difference in the orientation of the polymer chains parallel and perpendicular to the fiber.

Any patents or publications mentioned in this specification are herein incorporated by reference to the same extent as if each individual publication was specifically and individually indicated to be incorporated by reference.

This application claims priority of U.S. Provisional Patent Application 60/500,152 which is incorporated herein by reference.

One skilled in the art will readily appreciate that the present invention is well adapted to carry out the objects and obtain the ends and advantages mentioned, as well as those inherent therein. The apparatus and methods described herein are presently representative of preferred embodiments, are exemplary, and not intended as limitations on the scope of the invention. Changes therein and other uses will occur to those skilled in the art. Such changes and other uses are encompassed within the spirit of the invention as defined by the scope of the claims.

1. A process for producing a polymer fiber, the process comprising the steps of:
providing an apparatus, the apparatus including: a nozzle having a body with a bore defined therethrough, the bore having an inlet aperture and an outlet aperture, the bore having a first segment proximal to the inlet aperture having a first diameter, and a second segment proximal to the outlet aperture having a second diameter, the ratio of the first diameter to the second diameter ranges between 2:1-1000:1, inclusive;
providing a gas source for supplying a gas, the gas source coupled to the inlet aperture of the bore by a coupler;
placing a polymer mass in the bore or coupler; and
activating the gas source such that a polymer/gas mixture is formed in the bore or coupler and moved through the bore such that an extensional force acts to extend the polymer mass and a polymer fiber is produced.

2. The process of claim 1 wherein the polymer comprises a non-melt processible polymer.

3. The process of claim 1 wherein the polymer comprises PTFE.

4. The process of claim 1 wherein the polymer comprises a polymer selected from the group consisting of: polyacrylonitrile, polyolefins, cellulose acetates, cellulose nitrites, fluoropolymers, polyamides, polyimides, polystyrene, polysulfone, polyarylamides, polybutadienes, polybutenes, polycarbonates, polyesters, polyethylene, polypropylenes, polyvinyl acetates, polyurethanes, acrylates, methacrylates, polyvinylidene chlorides, silicones, styrenes, ethylene-methacrylic acid copolymers, ethylene-vinyl acetate copolymers, polyvinylacetate-methacrylic copolymers, polyaramides, polymethylmethacrylates and a combination thereof.

5. The process of claim 1 wherein the polymer is a composite selected from the group consisting of: a polymer/polymer composite, a polymer/ceramic composite, a polymer/metal composite, a polymer/solvent, polymer/organic composite and a combination thereof.

6. The process of claim 1 wherein the fiber has a diameter less than the diameter of the outlet aperture.

7. The process of claim 1 wherein the fiber has a diameter ranging from 10 nanometers to 50 microns.

8. The process of claim 1 wherein the fiber has a length ranging from 40 nanometers to 1 meter.

9. The process of claim 1 wherein the gas is an inert gas.

10. The process of claim 1 wherein the gas comprises a gas selected from the group consisting of: nitrogen, argon, neon, air, SF₆, helium, CF₄, H₂, steam, supercritical H2O, carbon dioxide, a C₁-C₃ fluorinated hydrocarbon gas, a C₁-C₃ hydrocarbon gas and a combination thereof.

11. The process of claim 1 further comprising the step of heating the polymer.

12. The process of claim 11 wherein the polymer is heated to a temperature below its melting point.

13. (Canceled)

14. (Canceled)

15. An apparatus for producing a polymer fiber, the apparatus comprising:
a nozzle, the nozzle comprising a body having a bore defined therethrough, the bore having an inlet aperture and an outlet aperture, the bore having a first segment proximal to the inlet aperture having a first diameter, and a second segment proximal to the outlet aperture having a second diameter, wherein the ratio of the first diameter to the second diameter ranges between 2:1-100:1, inclusive; and
a gas source for providing a gas, the gas source coupled to the inlet aperture of the bore by a coupler.

16. The apparatus of claim 15 wherein the bore tapers in diameter in a transition region between the first segment and the second segment.

17. The apparatus of claim 15 wherein a mixture of a polymer and a gas is disposed therein.

18. The apparatus of claim 17 wherein the mixture of a polymer and a gas comprises an inert gas.

19. The apparatus of claim 17 wherein the mixture of a polymer and a gas comprises a gas selected from the group consisting of: nitrogen, argon, neon, air, SF₆, helium, CF₄, H₂, steam, supercritical H2O, carbon dioxide, a C₁-C₃ fluorinated hydrocarbon gas, a C₁-C₃ hydrocarbon gas and a combination thereof.

20. The apparatus of claim 17 wherein the mixture of a polymer and a gas comprises PTFE and a gas selected from the group consisting of: nitrogen, argon, neon, air, SF₆, helium, CF₄, H₂, steam, supercritical H₂O, carbon dioxide, a C₁-C₃ fluorinated hydrocarbon gas, a C₁-C₃ hydrocarbon gas and a combination thereof.

21. The apparatus of claim 20 wherein mixture of a polymer and a gas is disposed therein.

22. The apparatus of claim 15 wherein the second diameter has a distance across a widest dimension ranging from 100 nanometers to 10 millimeters, inclusive.

23. The apparatus of claim 15 wherein the second diameter has a distance across a widest dimension ranging from 250 nanometers to 1 millimeter, inclusive.

24. The apparatus of claim 15 wherein the second diameter has a distance across a widest dimension ranging from 500 nanometers to 300 microns, inclusive.

25. The apparatus of claim 15 wherein the second segment has a length ranging from 0.01 millimeters to 1 meter, inclusive.

26. The apparatus of claim 15 wherein the second segment has a length ranging from 0.5 millimeters to 1 centimeter, inclusive.

27. The apparatus of claim 15 wherein the ratio of the first diameter to the second diameter ranges from 20:1-30:1, inclusive.

28. The apparatus of claim 15 wherein the gas source delivers gas at a pressure ranging from 50 psi-150,000 psi, inclusive.

29. The apparatus of claim 15 wherein the gas source delivers gas at a pressure ranging from 300 psi-30,000 psi, inclusive.

30. The apparatus of claim 15 further comprising a heating element in thermal communication with a polymer-containing portion of the apparatus.

31. The apparatus of claim 15 further comprising a temperature controller operatively connected to the heating element.

32. A composition for use in a jet blowing process for producing a polymer fiber, comprising in combination:
a polymer; and
a gas, the gas inert with respect to the polymer.

33. The composition of claim 32 wherein the gas comprises a gas selected from the group consisting of: nitrogen, carbon dioxide, argon, neon, air, SF₆, helium, CF₄, H₂, steam, supercritical H₂O, a C₁-C₃ fluorinated hydrocarbon gas, a C₁-C₃ hydrocarbon gas, and a combination thereof.

34. The composition of claim 32 wherein the gas is present in a concentration ranging from 0.1-40%, by weight, inclusive.

35. The composition of claim 32 wherein the gas is nitrogen present in a concentration ranging from greater than 0.1% to 40%, by weight, inclusive.

36. The composition of claim 32 wherein the gas is nitrogen present in a concentration ranging from greater than 1.0% to 10%, by weight, inclusive.

37. The composition of claim 32 wherein the gas is argon present in a concentration ranging from greater than 0.1% to 40%, by weight, inclusive.

38. The composition of claim 32 wherein the polymer comprises a non-melt processible polymer.

39. The composition of claim 32 wherein the polymer comprises a polymer selected from the group consisting of: polyacrylonitrile, polyolefins, cellulose acetates, cellulose nitrites, fluoropolymers, polyamides, polyimides, polystyrene, polysulfone, polyarylamides, polybutadienes, polybutenes, polycarbonates, polyesters, polyethylene, polypropylenes, polyvinyl acetates, polyurethanes, acrylates, methacrylates, polyvinylidene chlorides, silicones, styrenes, ethylene-methacrylic acid copolymers, ethylene-vinyl acetate copolymers, polyvinylacetate-methacrylic copolymers, polyaramides, polymethylmethacrylates and a combination thereof.

40. The composition of claim 32 wherein the polymer further comprises a component selected from the group consisting of: a second polymer, an organic component, an inorganic component, a solvent, a precursor component, and a combination thereof.

41. A composition of claim 32 wherein the polymer is a fluoropolymer.

42. The composition of claim 41 wherein the fluoropolymer comprises PTFE.

43. The composition of claim 41 wherein the polymer further comprises a component selected from the group consisting of: a second polymer, an organic component, an inorganic component, a solvent, a precursor component, and a combination thereof.

44. A process for producing a polymer fiber, the process comprising the steps of:
providing a polymer;
introducing a high pressure flow of a gas so as to create a flowing mixture of gas and polymer;
moving the mixture of gas and polymer through a passage, the passage having an inlet aperture and an outlet aperture, the passage having a first segment proximal to the inlet aperture having a first diameter, and a second segment proximal to the outlet aperture having a second diameter, the first diameter greater than the second diameter, such that a polymer fiber is formed, the fiber having a diameter smaller than the second diameter.

45. A process for producing a PTFE fiber, comprising the steps of:
providing a PTFE polymer;
heating the PTFE polymer to a temperature below 400° C.;
introducing a high pressure flow of a gas so as to create a flowing mixture of gas and PTFE polymer;
moving the mixture of gas and PTFE polymer through a passage, the passage having an inlet aperture and an outlet aperture, the passage having a first segment proximal to the inlet aperture having a first diameter, and a second segment proximal to the outlet aperture having a second diameter, the first diameter greater than the second diameter, such that a PTFE fiber is formed, the fiber having a diameter smaller than the second diameter.

46. The process of claim 45 wherein the PTFE fiber has a melting temperature % above 335° C.

47. The process of claim 45 wherein the mixture of gas and PTFE polymer further comprises a component selected from the group consisting of: a second polymer, an organic component, a solvent, an inorganic component, a precursor component, and a combination thereof.

48. The process of claim 45 wherein the PTFE fiber has a diameter in the range between 10 nanometers to 50 microns, inclusive.

49. The process of claim 45 wherein the gas comprises a gas selected from the 0° group consisting of: nitrogen, argon, neon, air, SF₆, helium, CF₄, H₂, steam, carbon dioxide, supercritical H₂O, a C₁-C₃ fluorinated hydrocarbon gas, a C₁-C₃ hydrocarbon gas, and a combination thereof.

50. A PTFE fiber characterized in that the fiber has a melting temperature above 335° C.

51. The PTFE fiber of claim 50 wherein the PTFE fiber has a diameter in the range between 10 nanometers to 50 microns, inclusive.

52. An article of manufacture comprising:
a PTFE fiber characterized in that the fiber has a melting temperature above 335° C.

53. The article of manufacture of claim 52 wherein the article is selected from the group consisting of: a medical device, a fabric, and a semi-permeable membrane.

54. A PTFE fiber characterized in that the fiber has a diameter in the range of 10 nanometers to 1 micron, inclusive.

55. An article of manufacture comprising:
a PTFE fiber characterized in that the fiber has a diameter in the range of 10 nanometers to 1 micron, inclusive.

56. A process for producing a polymer fiber, the process comprising the steps of:
providing a mixture of a polymer and a gas;
blowing the mixture of a polymer and a gas through a nozzle, the nozzle having an outlet aperture, such that a polymer fiber is produced, the polymer fiber characterized in that the fiber has a diameter less than the diameter of the outlet aperture of the nozzle.

57. The process of claim 56 wherein the polymer comprises a non-melt processible polymer.

58. The process of claim 56 wherein the polymer comprises PTFE.

59. The process of claim 56 wherein the diameter of the fiber is in the range of 10 nanometers to 50 microns.

60. The process of claim 56 wherein the mixture of gas and polymer further comprises a component selected from the group consisting of: a second polymer, an organic component, a solvent, an inorganic component, a precursor component, and a combination thereof.

61. The process of claim 60 wherein the organic component is a bioactive agent.

62.-67. (Canceled)
